(19) United States
(12) Patent Application Publication
(10) Pub. No.: US 2008/0223094 A1
(43) Pub. Date: Sep. 18, 2008

(54) Lock Key And Method Of Its Manufacture

(75) Inventor: Daniel Andersson, Eskilstuna (SE)

Correspondence Address: SUGHRUE MION, PLLC, 2100 PENNSYLVANIA AVENUE, N.W., SUITE 800, WASHINGTON, DC, 20037, US

(73) Assignee: ASSA AB, Eskilstuna (SE)

(21) Appl. No.: 11/916,453

(22) PCT Filed: May 31, 2006
(86) PCT No.: PCT/SE2006/000644

§ 371 Date: Jan. 18, 2008

(30) Foreign Application Priority Data
Jun. 10, 2005 (SE) 0501333-9

(51) Int. Cl. G07C 9/00; E05B 19/00

(52) U.S. Cl. 70/303 A; 70/393

(57) ABSTRACT

A lock key comprises a key blank (20) that has a gripping part (20a) and a key bit part (20b). A circuit board (34) that has mounted thereon electric circuits and a key contact part (35) connected electrically to the electric circuits are accommodated in a circuit board cradle (30) made of electrically non-conductive material. The circuit board cradle is fitted to the key blank. The placement of a circuit board and electric contact conductor in an electrically non-conductive material makes possible rational manufacture of the arrangement. Because the circuit board cradle made of electrically non-conductive material can be fixated in the key blank it is possible to position the electric contact conductor precisely, thereby ensuring a reliable electric contact function.

### FIELD OF INVENTION

The present invention relates generally to a lock key and more particularly to a key intended for an electromechanical lock and including an electric contact conductor connected to key-carried electronics for co-action with a lock-mounted electric conductor. The invention also relates to a method of manufacturing such a key.

### BACKGROUND OF THE INVENTION

Electromechanical lock arrangements of the kind which are designed to be manoeuvred by means of keys that include key electronics are known to the art. Such electronic means include electronic circuits, such as processors and memory circuits mounted on a circuit board. To enable communication with corresponding electronic means in the lock arrangement a key contact is disposed somewhere on the key, preferably on the key bit. Moreover, the actual key blank normally functions as an electric grounding, and hence the key electronic means is connected electrically to the key blank in some way or another.

It will be understood that many problems must be solved in connection with the design and manufacture of keys that are intended for electromechanical locks. Firstly, it is necessary to provide the key with an electric contact conductor for electrical connection of the key with the key-mounted electronics and also to mount this conductor in a pre-determined position. Secondly, it is necessary that the key blank will function as an electric grounding for the key electronics. It is also necessary to accommodate the key electronic means in a defined space. Finally, the key must be manufactured in a cost effective fashion.

### SUMMARY OF THE INVENTION

An object of the present invention is to provide a key of the above kind with which the above problems are solved, and also to provide a method of manufacturing the key.

The invention is based on the insight that the electronic means of the key, including circuit board and electric contact conductor, can be placed in a circuit board cradle that consists of an electrically non-conductive material, wherewith the cradle is suitably structured to enable it to be fitted to the key blank.

Accordingly, there is provided in accordance with the invention a key according to claim 1 and a method of manufacturing the key according to claim 9.

A key produced in accordance with the invention has several advantages over the known technology. Firstly, placement of a circuit board and an electric contact conductor in an electrically non-conductive material provides a rational method of manufacture. The possibility of fixating the non-electrically conductive cradle in the key blank enables the contact conductor to be precisely positioned.

According to one particularly preferred embodiment of a key constructed in accordance with the invention, that part of the cradle which accommodates the contact conductor is inserted into a dovetail groove in the key bit. This provides precise positioning of the electrical contact point while enabling rational fitting of the contact conductor at the same time.

### BRIEF DESCRIPTION OF THE DRAWINGS

An exemplifying embodiment of the invention will now be described with reference to the accompanying drawings in which

FIG. 1 is an exploded view of a lock key according to the invention, including all components;

FIG. 2 is an exploded view of a key blank and a circuit board cradle in respect of an inventive key;

FIGS. 2a and 2b are respective cross-sectional views through the key blank shown in FIG. 2, on a level with grooves for accommodating electric contact conductor and grounding connecting pin respectively;

FIG. 2c is a longitudinal sectioned view through the middle of the circuit board cradle;

FIG. 3 shows the key blank illustrated in FIG. 2 fitted to the cradle;

FIGS. 3a and 3b are respective cross-sectional views of the key blank shown in FIG. 3 showing the fitted circuit board cradle on a level with grooves for accommodating the electric contact conductor and the grounding connecting pin respectively;

FIG. 4 is a detailed view of the rear side of the circuit board cradle;

FIG. 5 is a detailed view of a fitted circuit board cradle although with the absence of a circuit board on the inventive key;

FIG. 6 shows the underside of a circuit board included in an inventive key;

FIG. 7 illustrates an electric battery contact included in an inventive key;

FIG. 8 is a detailed view of a key to which a battery is fitted;

FIG. 9 shows part of a key cover prior to fitting light conductors; and

FIG. 10 illustrates the key cover in FIG. 9 with fitted light conductors.

### DETAILED DESCRIPTION OF THE INVENTION

There now follows a detailed description of a preferred embodiment of the invention.

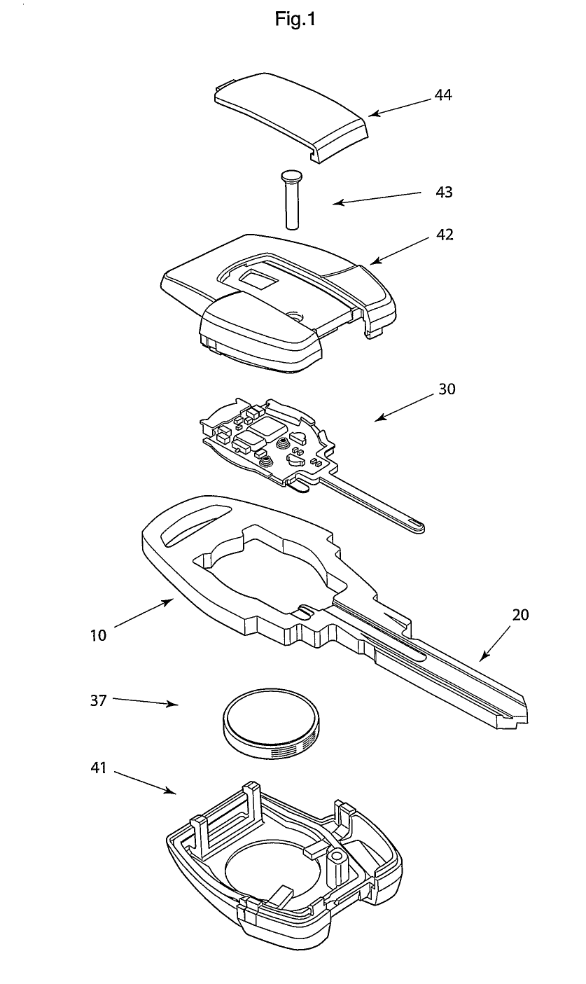

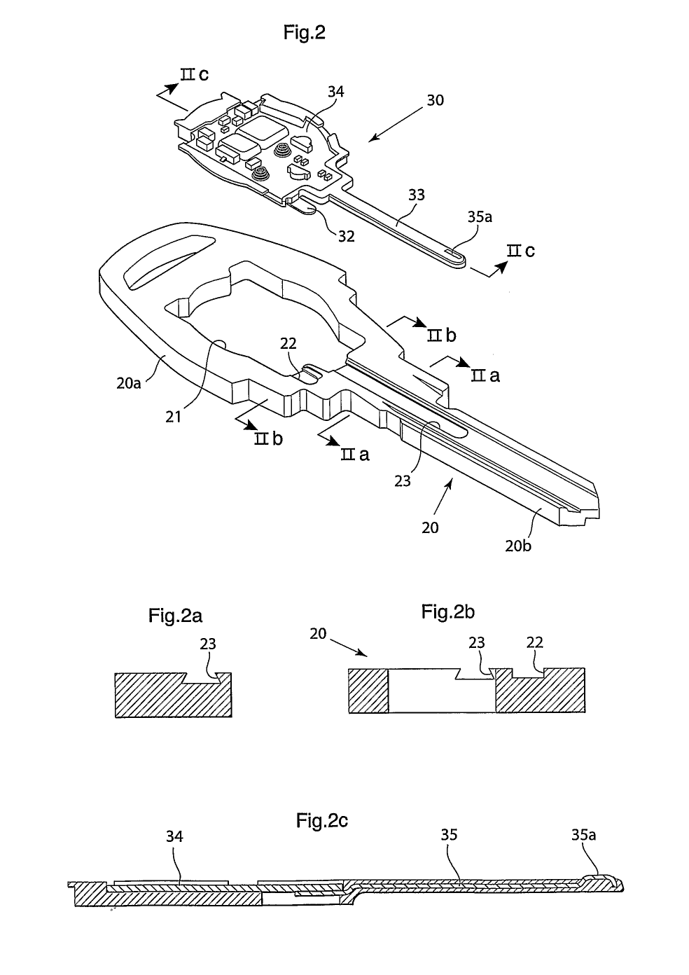

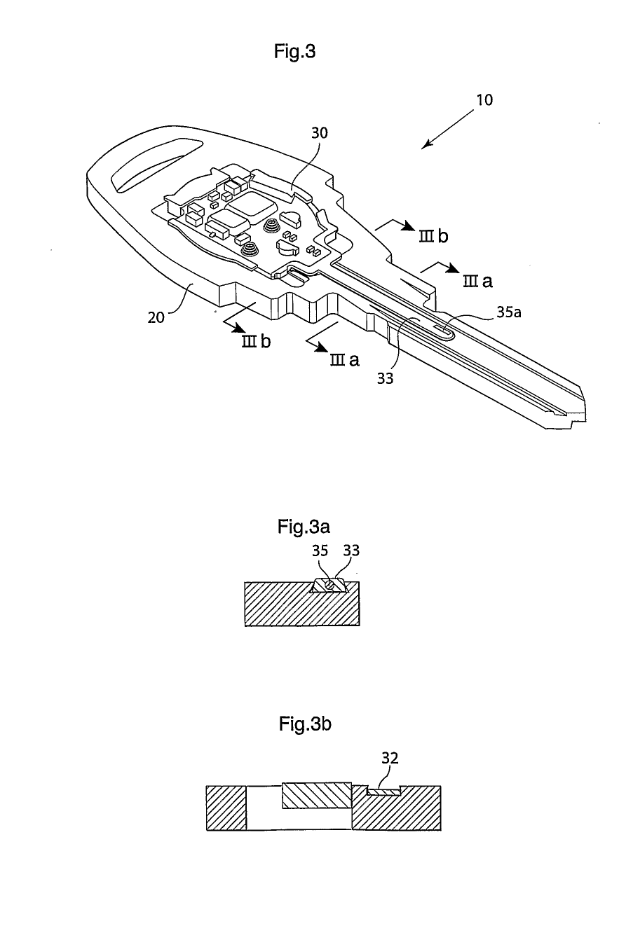

FIG. 1 is an exploded view of a key according to the present invention. This key, generally referenced 10 and intended for use in so-called electromechanical lock-cylinders, includes a key blank 20 comprised of a suitable electrically conductive metal and a circuit board cradle 30 comprised of a suitable electrically non-conductive material, such as a plastic material. The manner in which the cradle is fitted to the key blank will be described in detail in the following text with reference to FIGS. 2 and 3.

The key 10 includes an electric battery 37 for supplying electric current to electronic means disposed in the key and possibly also to electronic means disposed in a lock cylinder into which the key is inserted. The battery is held in place by a lower cover portion 41, which co-acts with the key blank through the medium of hooked elements. An upper cover portion 42 includes corresponding hooked elements (not shown). The cover consisting of said two cover parts and which is secured with the aid of a screw 43 which is covered by a lid 44, will be described in more detail in the following text.

FIG. 2 shows the key blank 20 and the circuit board cradle 30. The key blank is flat and generally of uniform thickness, and includes a gripping part 20a and a bit-part 20b of conventional design. The gripping part 20a has an external configuration which enables it to be held conveniently both in storage and in use. The gripping part includes a through-penetrating opening 21 that has a shape which harmonizes with the external contours of the circuit board cradle 30. The gripping part also includes a ground groove 22 which extends from the periphery of the opening 21 and which is intended to receive a grounding pin 32 which is connected electrically to a circuit board 34 placed in the circuit board cradle.

The bit-part 20b of the key bit is structured for insertion into a corresponding key slot in a lock cylinder (not shown). This part of the key bit thus has a form typical of a key bit and may include code surfaces. The bit-part of the key bit includes on one planar surface an elongate contact conductor groove 23 which is intended to accommodate a contact conductor part 33 of the circuit board carriage 30. The contact conductor groove 23 has a dovetail-shaped cross section, as evident from the sectioned views of FIGS. 2a and 3a.

The circuit board cradle 30 accommodates the circuit board 34, which includes the electronics required for functioning of the key. Thus, the circuit board includes a microprocessor having associated memory circuits for executing a program which, in co-action with electronics provided in the lock cylinder, controls the key for achieving a desired lock function. The plastic surrounds of the circuit board cradle embrace the sides of the circuit board and include an electrically conductive, elongate electric contact conductor 35; see the sectional view of FIG. 2c. This electric contact conductor, which may consist of thin silver-plated wire, is soldered to a soldering surface on the circuit. With the exception of an electric contact surface 35a and a soldering part 35b (see FIG. 5) on the electric contact conductor, the entire arrangement is fully enclosed in the plastic surrounds of the contact conductor part 33. The electric contact surface is obtained through the agency of a curved part 35a of the outer end at the outer end of the conductor. This curved part of the conductor thus protrudes above the edge of the groove 23 and is thereby able to co-act with an electric contact part of the lock cylinder.

The provision of a punctiform electric contact part instead of an elongate contact part provides the benefit of enabling the electric contact surface between key and lock to be well defined. This, in turn, prevents contact bounces that result in rereadings when inserting the key-bit portion in a key slot.

Fitting of the circuit board cradle 30 to the key blank 20 will now be described. The electric contact conductor part 33 of the circuit board cradle is initially pushed into the groove 23 provided in the key blank for this purpose. It will be understood that it is necessary to bend the cradle somewhat to this end. This presents no problem, since the cradle consists of a plastic material that allows some degree of deformation. When the contact conductor part has been pushed into the groove 23 almost to its bottom, the grounding pin 32 is pushed into its corresponding grounding groove 22. When the electric contact conductor part has been fully inserted, the remainder of the circuit board cradle is pushed into the opening 21 whereby the rear edge of the cradle is fixed against a corresponding harmonizing edge of the opening 21.

FIG. 3 illustrates the key blank 20 with a fitted circuit board cradle 30. It will be seen from FIG. 3 that the cradle is fixed against movement, so that the contact conductor part 33 will obtain a defined position in all directions. Because the contact conductor part is fully inserted in its intended groove 23 whilst the rear part of the cradle is, at the same time, in abutment with the edge of the opening in the key blank, the contact conductor part will be fixed longitudinally. As will be seen from FIG. 3a it will also be held fixed in the groove as a result of the dovetail shape of the groove.

The placement of the grounding pin in the groove 22 is also shown in FIG. 3b. The grounding pin is fixated by deformation of the key blank in the grounding groove 22. This can be achieved, for instance, with the aid of a press that works at a predetermined constant pressure. This will ensure both electric contact between the grounding pin and the key blank and also fixation of the grounding pin.

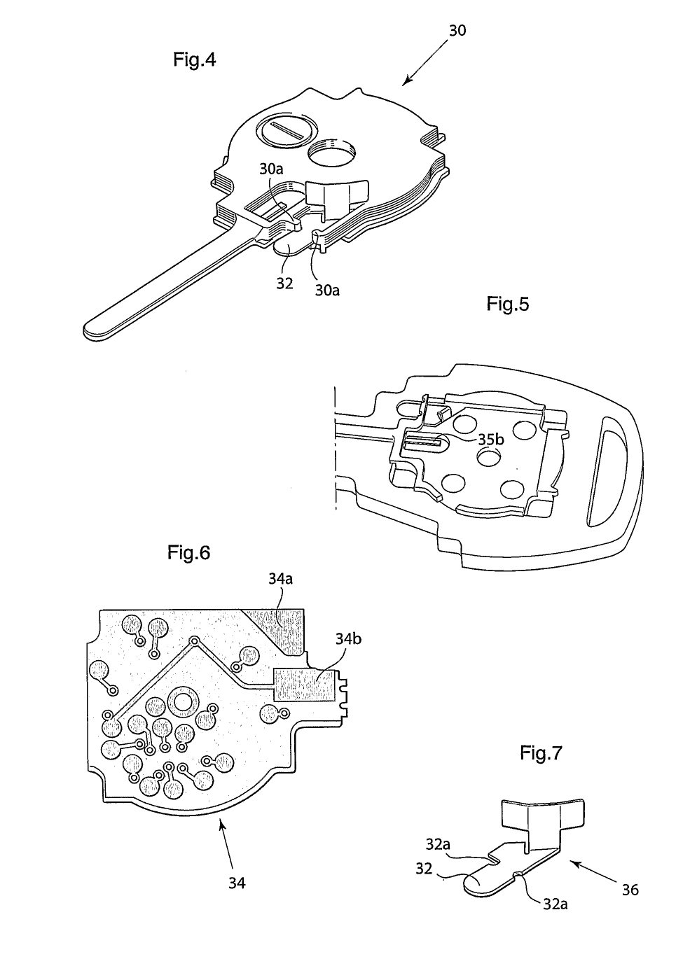

FIG. 4 illustrates the cradle from beneath and shows the grounding pin 32 in greater detail.

FIG. 7 shows the battery contact part 36 that includes the grounding pin 32. During assembly, the battery contact part is placed in a recess provided in the underside of the cradle for this purpose. Casting or moulding nib-like projections 30a harmonize with openings 32a at the base of the grounding pin 32, thereby ensuring that the battery contact will be positioned correctly. As will be seen from FIG. 6, the underside of the circuit board 34 is provided with a soldering surface 34e for the battery contact, wherewith the circuit board is soldered to the soldering surface on said board. This solves any problem with positioning and soldering of the grounding pin. The underside of the circuit board is also provided with a soldering surface 34b for the electric contact conductor 35. That part 35b of the conductor 35 soldered to the circuit board is shown in FIG. 5, which shows the cradle 30 in the absence of a circuit board 34.

The circuit board cradle 30 and fitted circuit board 34 is produced in the following manner. The electric contact conductor 35 is first positioned in a mould tool, whereafter the cradle is moulded in an appropriate plastic material with the aid of a moulding process. The electric contact conductor 35 is therewith moulded into the plastic material with the exception of that part 35a which functions as the electric contact point; see FIG. 2c. This terminates the manufacture of the actual circuit board cradle. The electric battery contact is then placed in position, whereafter the circuit board 34 is placed in the circuit board cradle such that the board will be enclosed sideways by the cradle. Finally, the battery contact part 36 and the contact conductor 35 are soldered to the circuit board. This method of procedure makes possible rational and repeated manufacture of a circuit board cradle that includes both electronics and electric contact conductors. This circuit board cradle can be used together with key blanks of varying external shapes, thereby enabling large series to be produced. The form of the circuit board cradle enables the key blank to be positioned precisely therein, which results in precise positioning of the contact point 35a and thereby a good functionality. Moreover, the separate manufacture of the circuit board cradle including electric contact conductors but without the circuit board affords significant flexibility with respect to changes in the electronics.

FIG. 8 shows the placement of an electric battery 37 in the opening 21 of the key blank 20.

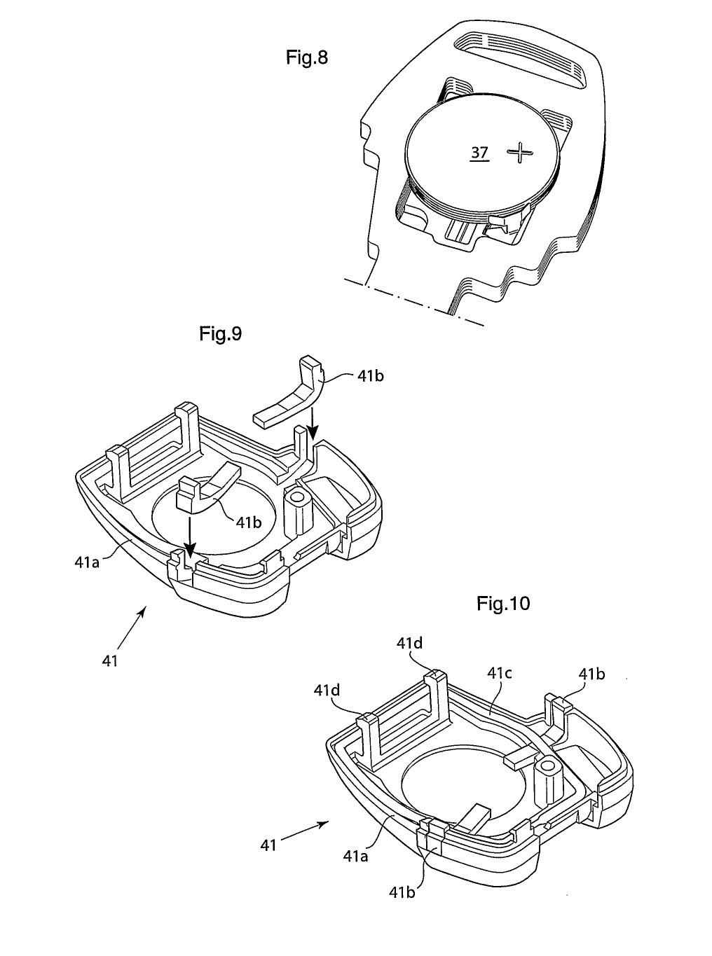

The lower cover part 41 and its manufacture will be described in the following with reference to FIGS. 9 and 10. The lower cover part comprises a cover part 41a which is moulded from an appropriate plastic material. Two light conductors 41b made of a light conductive plastic material are placed in recesses provided in the cover part 41a for this purpose. These light conductors are meant to conduct light from light emitting diodes placed on the circuit board adjacent the outer side of the key. The lower cover part 41 is produced by a two-stage moulding process in which the second stage includes the application of a string 41c of rubber material that extends partially over the fitted light conductors. This rubber string has two functions. Firstly, it holds the light conductors in place, which is a rational manner of fixating the conductors. Secondly, the rubber string functions as a seal between the lower cover part 41 and the key blank 20, so as to shield the circuit board 34 against the effect of moisture, etc.

A corresponding string is provided on the upper cover part 42.

The lower cover part 41 also has two hooks 41d which are intended to engage the rear edge of the opening 21 in the key blank. Corresponding hooks (not shown) are also provided on the upper cover part, although at a smaller distance apart than the hooks on the lower cover part 41. Subsequent to assembly, the hooks on the upper cover part 42 will thus be located inwardly of the hooks 41d on the lower cover part.

Although there has been described a preferred embodiment of a key constructed in accordance with the invention, the person of normal skill in this art will realize that the present invention is not restricted to this embodiment, and that variations and modifications can be made within the scope of the accompanying claims.

For instance, although the groove 23 for accommodating the electric contact conductor part 33 has a dovetail-like shape it will be understood that this part of the conductor can be fixated in some other way, for instance by means of an adhesive.

Although a grounding groove that includes straight edges has been shown, it will be understood that this groove may have a dovetail configuration.

1. A lock key comprising
a key blank that includes a gripping part and a key-bit part;
a circuit board that is fitted with electric circuits; and
a key contact part which is connected electrically to said electric circuits, characterized by
a circuit board cradle made of an electrically non-conductive material which the circuit board and key-contact part are accommodated, wherein
the circuit board cradle is fitted to the key blank, and wherein
the circuit board cradle has an electric contact conductor part in which there is moulded an electric contact conductor which is connected electrically to the circuit board, and wherein the electric contact conductor part is disposed in an electric contact conductor groove provided in the key blank.

2. The key according to claim 1, characterized in that the electric contact conductor part has a dovetail-shaped cross-section and that the electric contact conductor groove has a dovetail shape, said groove functioning to fixate the electric contact conductor part in said contact conductor groove.

3. The key according to claim 1, characterized in that the electric contact conductor part is fixated in said groove by means of an adhesive.

4. The key according to claim 1, characterized in that an electric contact part of the electric contact conductor includes a bent or curved part of the contact conductor that protrudes up over the edge of the electric contact conductor groove.

5. The key according to claim 1, characterized by a grounding part which is connected electrically to the circuit board, wherein the key blank includes a grounding groove in which said grounding part is fixed.

6. The key according to claim 5, characterized in that the grounding part is fixated in the grounding groove by deformation of the key blank in said grounding groove.

7. The key according to claim 1, characterized in that the edge of the circuit board cradle abuts the edge of an opening in the key blank.

8. A method of manufacturing a key for an electromechanical lock, characterized by the steps of
positioning an electric contact conductor in a mould;
generally moulding the electric contact conductor in a circuit board cradle made of an electrically non-conductive material;
placing a circuit board in the circuit board cradle;
placing the circuit board cradle in a recess or opening in the key blank: and
connecting the contact conductor electrically to the circuit board.

9. The method according to claim 8, characterized by the step of placing that part of the circuit board cradle in which the electric contact conductor is moulded in a dovetail groove.
